(19) United States
(12) Patent Application Publication
(10) Pub. No.: US 2015/0301784 A1
(43) Pub. Date: Oct. 22, 2015

(54) WIRELESS SYSTEM AND CONTROL METHOD OF WIRELESS SYSTEM

(71) Applicant: NEC CORPORATION, Tokyo (JP)

(72) Inventors: Kenichi MARUHASHI, Tokyo (JP); Daisuke INOUE, Tokyo (JP); Kouji KOBUKATA, Tokyo (JP); Tadashi TAKAHAMA, Tokyo (JP); Ken TANAKA, Tokyo (JP); Shuuya YAMAMOTO, Tokyo (JP)

(73) Assignee: NEC Corporation, Tokyo (JP)

(21) Appl. No.: 14/440,486

(22) PCT Filed: Dec. 11, 2013
(86) PCT No.: PCT/JP2013/007288

§ 371 Date: May 4, 2015

(30) Foreign Application Priority Data
Dec. 19, 2012 (JP) 2012-276369

(51) Int. Cl. G06F 3/14; G09G 5/12; G06F 3/147

(52) U.S. Cl. CPC G06F 3/1454; G06F 3/147; G09G 5/12; G09G 2380/08; G09G 2370/16; G09G 2370/22

(57) ABSTRACT

It is an object to provide a wireless system and a control method of the wireless system having improved portability and display performance.

[Solution] A wireless system of the present invention is characterized by including a first wireless terminal including first narrow area wireless communication means, first display means, and first biometric information obtaining means configured to obtain user's biometric information, and a second wireless terminal including second narrow area wireless communication means capable of communicating with the first narrow area wireless communication means, and second display means, wherein the first display means is smaller than the second display means.

### TECHNICAL FIELD

This invention relates to a wireless system and a control method of the wireless system.

### BACKGROUND ART

In recent years, services and the like are provided to obtain biometric information about biometrics of a user, and provide advice to the user on the basis of the information, or allow a corporation to use the information for marketing and transmit an advertisement suitable for the preference of the user. A portable wireless terminal is carried everyday and is therefore suitable for obtaining various kinds of health information and life information.

PTL 1 describes an example of a biometric information measurement system in which a portable wireless terminal obtains biometric information, and transmits the biometric information to a remote terminal via the Internet network. FIG. 13 is a block configuration diagram illustrating a portable information device 500 and a biometric information measurement device 600 included in a biometric information measurement system described in PTL 1. The portable information device 500 includes a first data transmission and reception unit 501 configured to receive biometric information data from the biometric information measurement device 600, and a first measurement unit 502 configured to measure an exercise intensity serving as behavior information of the user of the portable information device 500 which is one piece of biometric information. The portable information device 500 includes a storage unit 503 storing data received by the first data transmission and reception unit 501 and the exercise intensity of the user measured by the first measurement unit 502 serving as the biometric information data. The portable information device 500 includes an individual information storage unit 504 storing an identifier for identifying the user of the portable information device 500 and individual information such as age, sex, and height, and a control unit 505 constituted by a CPU for controlling each unit. The portable information device 500 includes a battery power supply unit 506 causing each unit of the portable information device 500 to operate with a battery.

The biometric information measurement device 600 includes a second measurement unit 602 configured to measure biometric information. The biometric information measurement device 600 includes a second data transmission and reception unit 601 connecting with the first data transmission and reception unit 501 of the portable information device 500 and transmitting the data measured by the second measurement unit 602 to the portable information device 500. The biometric information measurement device 600 includes a wireless communication unit 603 configured to wirelessly transmit data stored in the storage unit 503 of the portable information device 500, and a power supply unit 604 causing each unit of the biometric information measurement device 600 to operate with a battery. The biometric information measurement device 600 includes a biometric information measurement device display unit 605 reading and displaying data stored in the storage unit 503 during connection with the portable information device 500. The biometric information measurement device 600 includes a biometric information measurement device operation unit 606 configured to input selection of a display content on the biometric information measurement device display unit 605 and a command of transmission and reception with the second data transmission and reception unit 601.

FIG. 14 is a schematic diagram illustrating operation of usage procedure and biometric information management of the portable information device 500 and the biometric information measurement device 600 of PTL 1.

First, as shown in FIG. 14(A), the portable information device 500 is connected to the biometric information measurement device 600. Subsequently, by pressing a biometric information measurement device operation unit 606a of the biometric information measurement device 600 as shown in FIG. 14(B) several times, an item name of biometric information data transmission stored in the portable information device 500 is displayed on the biometric information measurement device display unit 605. When the control unit 505 is requested to transmit the biometric information data by pressing the enter button 606b, the portable information device 500 uses the wireless communication unit 603 to transmit the biometric information data to the relay device, and transmits the biometric information data via the Internet network to a remote terminal.

As described above, the user carries the portable information device 500 with him or her at all times, and connects the portable information device 500 to the biometric information measurement device 600 and performs operation while checking the display of the biometric information measurement device 600. Then, the user can transmit the biometric information data stored in the portable information device 500 via the biometric information measurement device 600, and the relay device can transmit the biometric information data via the Internet network to the remote terminal.

### CITATION LIST

### Patent Literature

[PTL 1] Japanese Patent Laid-Open No. 2004-255016

### SUMMARY OF THE INVENTION

### Problems to be Solved by the Invention

However, the invention described in PTL 1 involves the following problem. Since the portable information device 500 includes the first measurement unit 502 measuring the exercise intensity serving as the user's behavior information, the portable information device 500 is preferably a small terminal that can be easily attached to the user. However, even if the portable device terminal 500 includes display means such as a liquid crystal display, there is no choice but to make the display means a small display unit, and it used to be impossible to achieve not only the portability but the viewability.

Since the portable information device 500 measures the exercise intensity serving as the user's behavior information, it is necessary for the user to carry the portable information device 500 with him or her in everyday life. Therefore, sometimes, the user may forget to physically connect the portable device terminal 500 to the biometric information measurement device 600. It is necessary to obtain the biometric information with a regular interval, and therefore, when the portable device terminal 500 is not frequently physically connected to the biometric information measurement device 600, the portable device terminal 500 and the biometric information measurement device 600 are unable to function as the biometric information measurement system.

It is an object of the present invention to provide a wireless system and a control method of the wireless system solving the above problem.

### Means for Solving the Problems

A wireless system of the present invention includes a first wireless terminal including wide area wireless communication means connecting to an external system, first narrow area wireless communication means, first display means, and first biometric information obtaining means configured to obtain user's biometric information, and a second wireless terminal including second narrow area wireless communication means capable of communicating with the first narrow area wireless communication means, and second display means, wherein the first display means is smaller than the second display means.

The control method of the wireless system of the present invention includes, in a first wireless terminal, causing wide area wireless communication means communicate with an external network, obtaining user's biometric information, causing a first display unit to display information related to the obtained biometric information, and transmitting the information related to the biometric information displayed on the first display unit via first narrow area wireless communication means to a second terminal, and the control method of the wireless system includes, in a second wireless terminal, causing a second displaying unit larger than the first display unit to display the received information about the biometric information received from the first wireless terminal via second narrow area wireless communication means

### Advantage of the Invention

According to the present invention, the wireless system and the control method of the wireless system that solve the above problem are provided.

### BRIEF DESCRIPTION OF THE DRAWINGS

FIG. 1 is a schematic diagram illustrating a wireless system according to a first exemplary embodiment.

FIG. 2 is a schematic diagram illustrating a wireless system according to a second exemplary embodiment.

FIG. 3 is a schematic diagram illustrating a first example of the wireless system according to the second exemplary embodiment.

FIG. 4 is a schematic diagram illustrating a second example of the wireless system according to the second exemplary embodiment.

FIG. 5 is a diagram illustrating a communication of a first wireless terminal in a wireless system according to a third exemplary embodiment.

FIG. 6 is a schematic diagram illustrating a configuration of an example of the wireless system according to the third exemplary embodiment.

FIG. 7 is a diagram illustrating a communication of a first wireless terminal, a second wireless terminal, and a third wireless terminal of an example of the wireless system according to the third exemplary embodiment.

FIG. 8 is a diagram illustrating a communication of a first wireless terminal and a second wireless terminal of the wireless system according to the fourth exemplary embodiment.

FIG. 9 is a schematic diagram illustrating a configuration of an example of the wireless system according to the fourth exemplary embodiment.

FIG. 10 is a diagram illustrating a communication a first wireless terminal, a second wireless terminal, and a third wireless terminal in an example of the wireless system according to the fourth exemplary embodiment.

FIG. 11 is a diagram illustrating a communication of a first wireless terminal and a second wireless terminal in a wireless system according to a fifth exemplary embodiment.

FIG. 12 is a diagram illustrating a communication of a first wireless terminal, a second wireless terminal, and a third wireless terminal in an example of the wireless system according to the fifth exemplary embodiment.

FIG. 13 is a block configuration diagram illustrating a portable information device and a biometric information measurement device according to PTL 1.

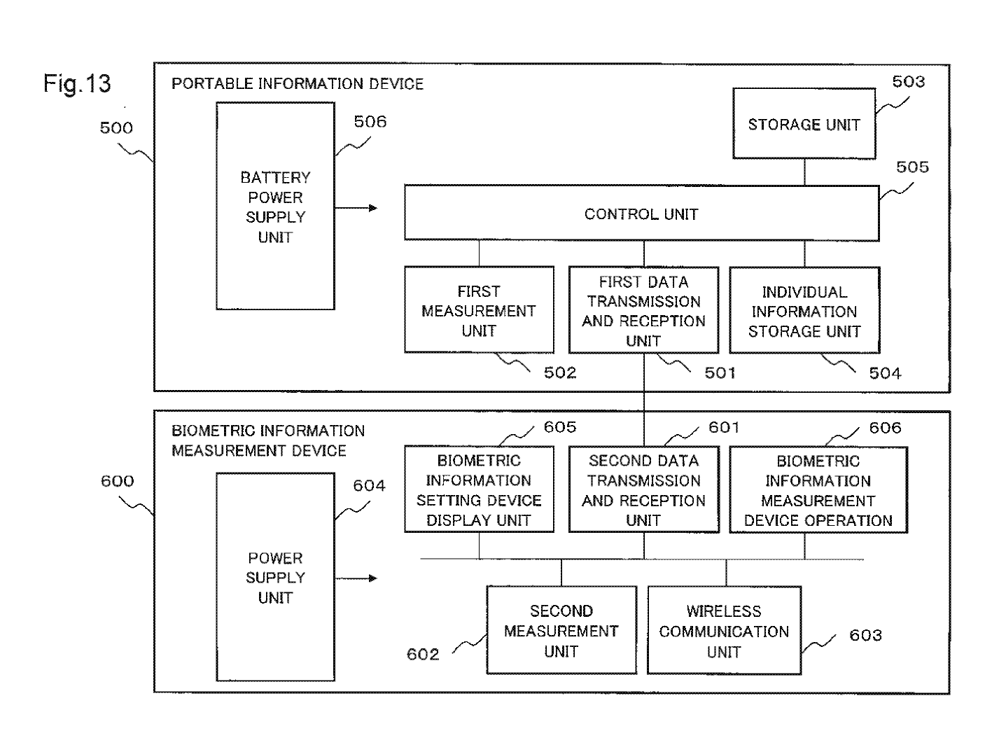

FIG. 14 is a schematic diagram illustrating usage procedure of the portable information device and the biometric information measurement device according to PTL 1.

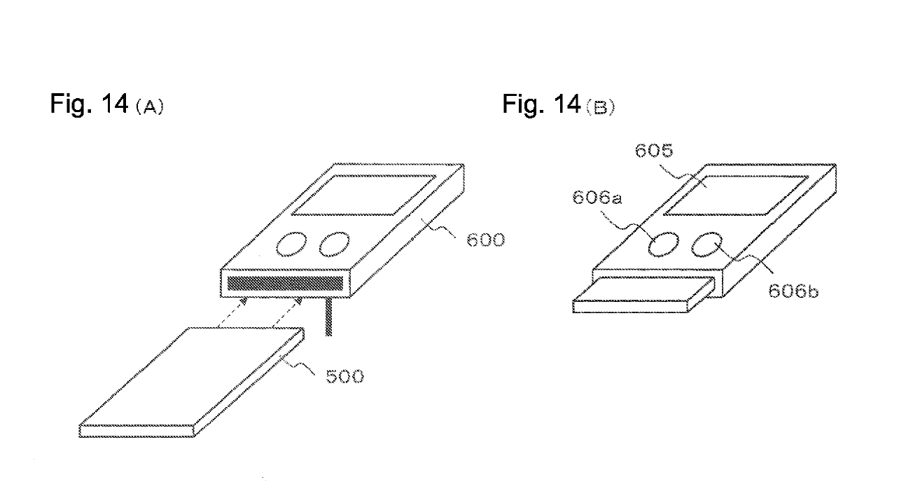

### MODES FOR CARRYING OUT THE INVENTION

### First Exemplary Embodiment

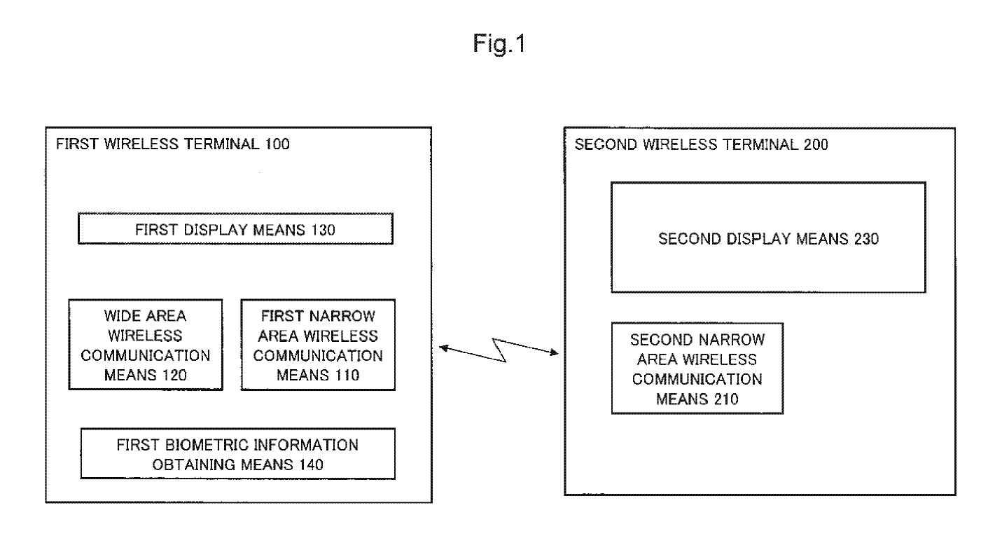

A wireless system according to the first exemplary embodiment of the present invention will be hereinafter explained with reference to FIG. 1. FIG. 1 is a schematic diagram illustrating the wireless system according to the first exemplary embodiment of the present invention. The wireless system according to the first exemplary embodiment includes a first wireless terminal 100 and a second wireless terminal 200. The first wireless terminal 100 includes first narrow area wireless communication means 110, wide area wireless communication means 120 connecting to an external system, not shown, first display means 130, and first biometric information obtaining means 140. The second wireless terminal 200 includes first narrow area wireless communication means 110, second narrow area wireless communication means 210 capable of performing communication, and second display means 230.

The first narrow area wireless communication means 110 and the second narrow area wireless communication means 210 may use, for example, wireless communication means capable of performing communication based on wireless LAN (Local Area Network) of which communication range is about 100 m. The first narrow area wireless communication means 110 and the second narrow area wireless communication means 210 can communicate with each other.

The wide area wireless communication means 120 may use wireless communication means capable of connecting to an external system via a base station, not shown, by means of wireless communicating using a mobile communication network.

The first display means 130 and the second display means 230 may use any display means as long as it can display information, and can use a liquid crystal display, an organic EL (Electro-Luminescence) display, and the like. The first display means 130 is smaller than the second display means 230.

The first biometric information obtaining means 140 may use any means as long as it can obtain information about user's biometric information. The first biometric information obtaining means 140 may use, for example, a sensor capable of detecting a blood pressure, a pulse, a heart rate, a body temperature, a sweating amount, and the like. The first biometric information obtaining means 140 may use an acceleration sensor capable of recording the number of steps taken by the user, a microphone capable of recording the activity amount of the user, an image sensor for capturing an image of meal and estimating the calorie taken, and the like.

When the first wireless terminal 100 is a cellular phone carried with the user in everyday life, the first wireless terminal 100 cannot have large display means implemented thereon from the perspective of ensuring portability, and this reduces the viewability. According to the wireless system of the first exemplary embodiment, for example, the first narrow area wireless means 110 and the second narrow area wireless means 210 communicate with each other, and information displayed on the first display means 130 can be displayed on the second display means 230. With the above configuration, the second display means 230 can be substituted for the first display means 130, so that the viewability can be improved, and not only the portability but also the viewability can be achieved.

According to the wireless system of the first exemplary embodiment, the first narrow area wireless communication means 110 and the second narrow area wireless communication means 210 can communicate. With this configuration, the first wireless terminal 100 and the second wireless terminal 200 can share the biometric information obtained by the first biometric information obtaining means 140 of the first wireless terminal 100 without physically connecting the first wireless terminal 100 and the second wireless terminal 200. Therefore, even if the user does not physically connect the first wireless terminal 100 with the second wireless terminal 200, the first wireless terminal 100 and the second wireless terminal 200 achieve the function of the system for obtaining the biometric information.

Other effects of the wireless system according to the first exemplary embodiment will be explained based on specific examples. For example, the first wireless terminal 100 is considered to be a terminal that is brought to the outside when the user goes outside but is limited to the functions such as telephone call, e-mail, photo shooting, acquisition of health information, life information, and the like. For example, the second wireless terminal 200 is considered to be a tablet terminal, and it is assumed that the second wireless terminal 200 is larger than the first wireless terminal 100, and in many cases, the user does not bring the second wireless terminal 200 with him or her when going outside.

When the user comes home with the first wireless terminal 100, the first wireless terminal 100 and the second wireless terminal 200 communicate with each other via the first narrow area wireless communication means 110 and the second narrow area wireless communication means 210, so that the first wireless terminal 100 and the second wireless terminal 200 can share the biometric information. For example, the first wireless terminal 100 is limited to phone call, e-mail transmission and reception, photo shooting, acquisition of biometric information using the wide area wireless communication means 120, and therefore, the size of the first wireless terminal 100 can be reduced to enhance portability. On the other hand, the second wireless terminal 200 does not have any wide area wireless communication means, and therefore, the second wireless terminal 200 cannot make phone call or transmit and receive e-mails by itself. When the user is wearing the first wireless terminal 100, the first wireless terminal 100 is placed in proximity to the second wireless terminal 200, the second wireless terminal 200 can make phone call or transmit and receive e-mails via the second narrow area wireless communication means 210, the first narrow area wireless communication means 110, and the wide area wireless communication means 120.

It is noted that a wide area wireless communication performed by the wide area wireless communication means 120 may normally incur a communication charge. On the other hand, a narrow area wireless communication performed by the first narrow area wireless terminal 110 and the second narrow area wireless terminal 210 basically does not incur any communication charge. The first wireless terminal 100 connects to an external system via the wide area wireless communication means 120. The second wireless terminal 200 can connect to an external system via the second narrow area wireless communication means 210, the first narrow area wireless communication means 110, and the wide area wireless communication means 120. In this case, two wireless terminals can use a single wide area wireless communication, which suppresses the increase in the communication charge required for the wide area wireless communication.

The external system is considered to be a system for controlling telephone call and data communication prepared by a mobile communication corporation, and a system for processing and analyzing biometric information. The external system can provide an advice in terms of health to the user on the basis of an analysis performed by the system for processing and analyzing biometric information. With the external system, a corporation can use the biometric information for marketing and transmit an advertisement suitable for the preference of the user on the basis of an analysis performed by the system for processing and analyzing biometric information. In the external system, the system for controlling telephone call and data communication and the system for processing and analyzing biometric information may be the same system and accommodated in a single system, or may be separate systems connected via a network and the like. The analysis performed by the system for processing and analyzing biometric information may be allowed to be viewed on the first display means 130 of the first wireless terminal 100 or the second display means 230 of the second wireless terminal 200. The analysis performed by the system for processing and analyzing biometric information may be allowed to be viewed on a PC (Personal Computer) and the like owned by the user via the Internet.

The first wireless terminal 100 and the second wireless terminal 200 may have input means. The input means may be buttons such as a keyboard and numeric keys, or may be the first display means 130 and the second display means 230 having touch screens.

In the wireless system according to the first exemplary embodiment, the first narrow area wireless communication means 110 and the second narrow area wireless communication means 210 can communicate, and therefore, as described above, information displayed on the first display means 130 can be displayed on the second display means 230. With this configuration, the user uses the input means of the first wireless terminal 100 and may perform operation while seeing the second display means 230 larger than the first display means 130.

For example, the user can perform key input operation by using the input means of the first wireless terminal 100, and while seeing the second display means 230 provided with the second wireless terminal 200, the user can write a communication message of an e-mail. When the user is skilled in the operation of the input means of the first wireless terminal 100, the user can easily perform operation. When a touch screen is used as the input means, the user can perform input operation by using the second display means 230 larger than the first display means 130, which improves the operability.

Instead of the input device and the first display device 130 provided with the first wireless terminal 100, the touch screen provided with the second display means 230 can be used. With this configuration, user's operation and viewability are improved in management operation performed for the entire wireless system or the first wireless terminal 100, information input operation, displaying of information, and the like.

### Second Exemplary Embodiment

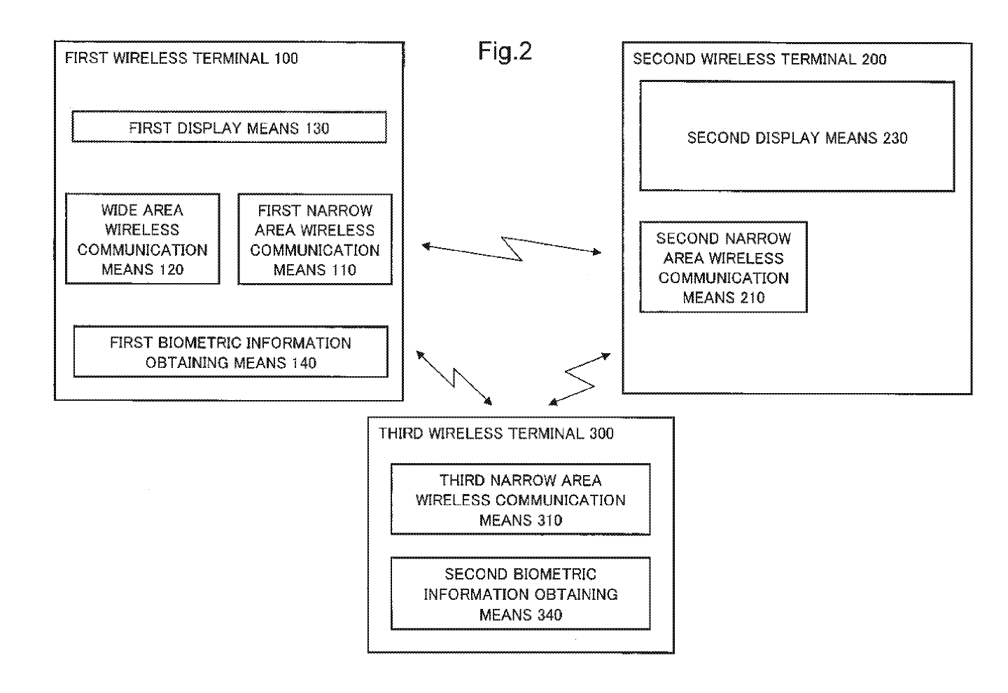

A wireless system according to the second exemplary embodiment will be explained with reference to FIG. 2. FIG. 2 is a schematic diagram illustrating the wireless system according to the second exemplary embodiment. The configuration of the wireless system according to the second exemplary embodiment is different from the configuration of the wireless system according to the first exemplary embodiment in that the wireless system according to the second exemplary embodiment includes not only the first wireless terminal 100 and the second wireless terminal 200 but also the third wireless terminal 300.

The third wireless terminal 300 includes a third narrow area wireless communication means 310 and a second biometric information obtaining means 340. The third narrow area wireless communication means 310 can use the same wireless communication means as the first narrow area wireless communication means 110 and the second narrow area wireless communication means 210 according to the first exemplary embodiment. The third narrow area wireless communication means can communicate with at least one of the first narrow area wireless communication means 110 and second narrow area wireless communication means 210.

The second biometric information obtaining means 340 obtains information about biometrics of the user. A sensor similar to the first biometric information obtaining means 140 according to the first exemplary embodiment can be employed for the second biometric information obtaining means 340.

The third wireless terminal 300 transmits biometric information obtained by the second biometric information obtaining means 340 to at least any one of the first narrow area wireless communication means 110 and the second narrow area wireless communication means 210. When the second narrow area wireless communication means 210 receives biometric information, the second narrow area wireless communication means 210 transmits the biometric information to the first narrow area wireless communication means 110. When the first narrow area wireless communication means 110 receives the biometric information, the first narrow area wireless communication means 110 transmits the biometric information to the wide area wireless communication means 120. The wide area wireless communication means 120 transmits the biometric information to an external system.

The first narrow area wireless communication means 110 directly receives the biometric information from the third narrow area wireless communication means 310, the first narrow area wireless communication means 110 transmits the biometric information to the wide area wireless communication means 120. The wide area wireless communication means 120 transmits the biometric information to an external system.

According to the wireless system of the second exemplary embodiment, the second biometric information obtaining means 340 of the third wireless terminal 300 can obtain the biometric information. For example, the third wireless terminal 300 can include, as the second biometric information obtaining means 340, biometric information obtaining mean that is difficult to be provided with the first wireless terminal 100. In addition, even when a person other than the user goes outside with the first wireless terminal 100, the third wireless terminal 300 allows the second biometric information obtaining means 340 to obtain biometrics information about the user who does not go outside.

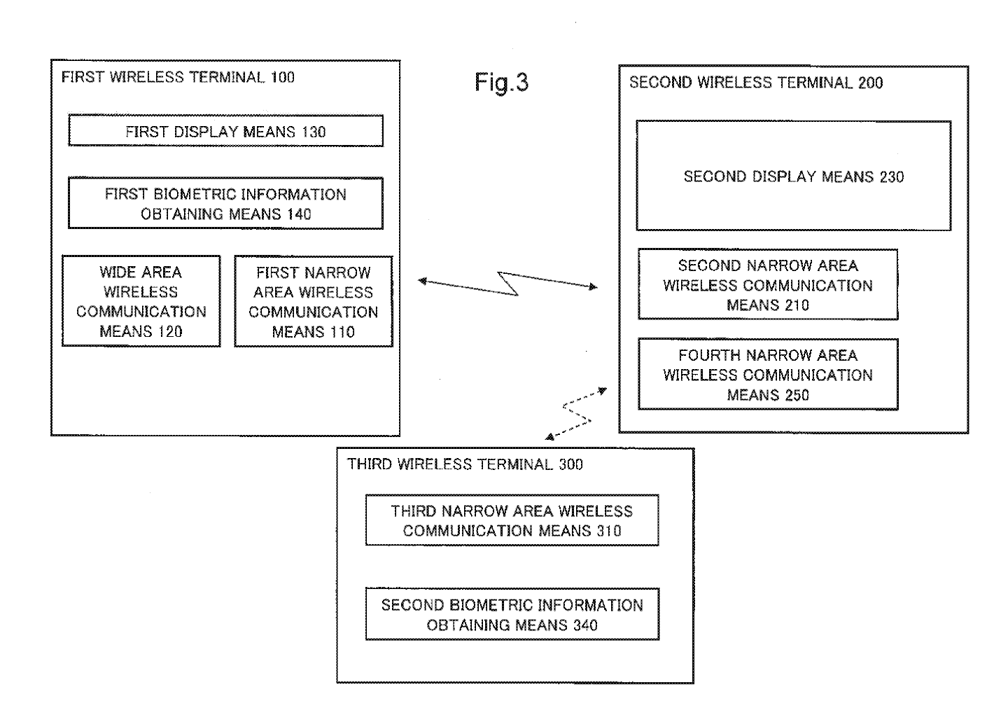

The following configuration can be employed as another example of the second exemplary embodiment. FIG. 3 is a schematic diagram illustrating a first example of the wireless system according to the second exemplary embodiment. In the wireless system according to FIG. 3, not only the third wireless terminal 300 but also the second wireless terminal 200 includes the fourth narrow area wireless communication means 250.

The fourth narrow area wireless communication means 250 can communicate with the third narrow area wireless communication means 310. In the wireless system according to FIG. 3, third narrow area wireless communication means 310 and the fourth narrow area wireless communication means 250 use wireless communication means of which electric power consumption is less than the first narrow area wireless communication means 110 and the second narrow area wireless communication means 210. For example, wireless communication means of Bluetooth Low Energy (registered trademark) specification consuming less power than wireless LAN is preferable.

The third wireless terminal 300 transmits the biometric information obtained by the second biometric information obtaining means 340 via the third narrow area wireless communication means 310 to the fourth narrow area wireless communication means 250. When the fourth narrow area wireless communication means 250 receives the biometric information, the fourth narrow area wireless communication means 250 transmits the biometric information to the second narrow area wireless communication means 210. The second narrow area wireless communication means 210 transmits the biometric information to the first narrow area wireless communication means 110. When the first narrow area wireless communication means 110 receives the biometric information, the first narrow area wireless communication means 110 transmits the biometric information to the wide area wireless communication means 120. The wide area wireless communication means 120 transmits the biometric information to an external system.

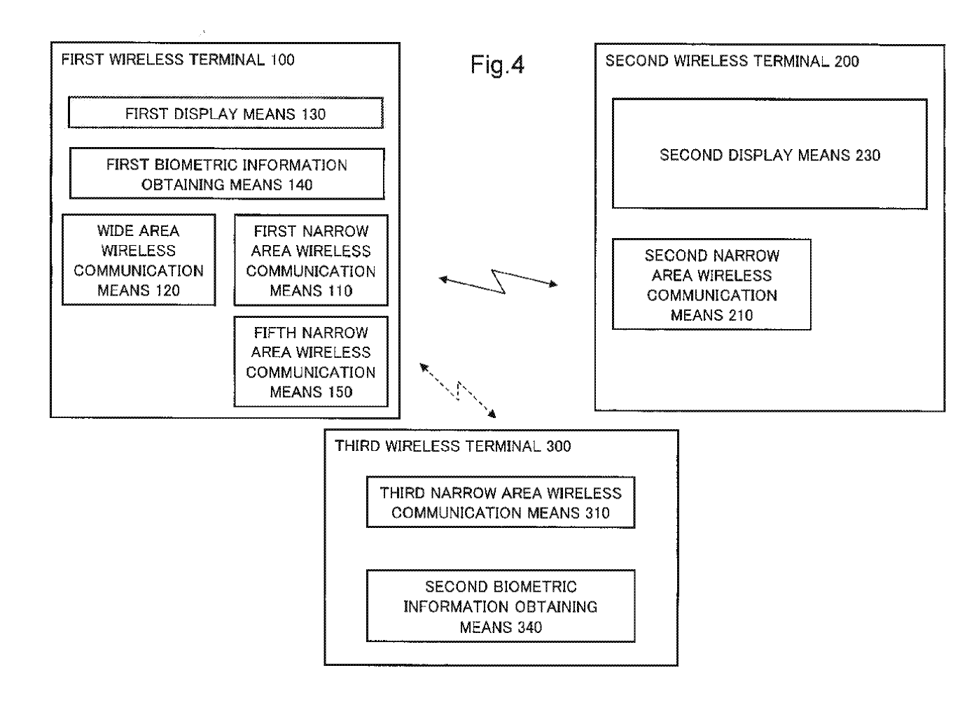

FIG. 4 is a schematic diagram illustrating a second example of the wireless system according to the second exemplary embodiment. In the wireless system according to FIG. 4, not only the third wireless terminal but also the first wireless terminal 100 includes fifth narrow area wireless communication means 150.

The fifth narrow area wireless communication means 150 can communicate with the third narrow area wireless communication means 310. In the wireless system according to FIG. 4, the third narrow area wireless communication means 310 and the fifth narrow area wireless communication means 150 use wireless communication means of which electric power consumption is less than the first narrow area wireless communication means 110 and the second narrow area wireless communication means 210. For example, wireless communication means of Bluetooth Low Energy (registered trademark) specification consuming less power than wireless LAN is preferable.

The third wireless terminal 300 transmits the biometric information obtained by the second biometric information obtaining means 340 via the third narrow area wireless communication means 310 to the fifth narrow area wireless communication means 150. When the fifth narrow area wireless communication means 150 receives the biometric information, the fifth narrow area wireless communication means 150 transmits the biometric information to the wide area wireless communication means 120. The wide area wireless communication means 120 transmits the biometric information to the external system.

The communication performed between the first narrow area wireless communication means 110 and the second narrow area wireless communication means 210 is used to transfer a large amount of picture data, or is used when the second wireless terminal 200 accesses the external system via the first wireless terminal 100. Therefore, a high communication speed is required although the electric power consumption increases. On the other hand, the biometric information relatively has a less amount of information, and a lower electric power consumption is preferred as compared rather than a high communication speed. In particular, the biometric information is generated as necessary, and therefore, frequent communication is expected, and accordingly, it is important to reduce the electric power consumption. According to the first example and the second example of the wireless system according to the second exemplary embodiment, the fourth narrow area wireless communication means 250 or the fifth narrow area wireless communication means 150 and the third narrow area wireless communication means 310 are used to transmit biometric information, and therefore, the electric power consumption can be reduced.

### Third Exemplary Embodiment

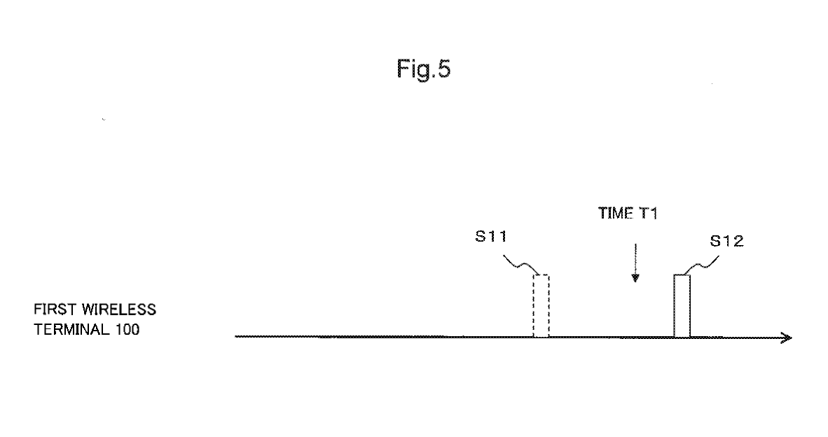

A wireless system according to the third exemplary embodiment will be explained with reference to FIG. 5. The configuration of the wireless system according to the third exemplary embodiment is not different from the configuration of the wireless system as shown in FIGS. 1 to 4 according to the first and second exemplary embodiments. The wireless system according to the third exemplary embodiment is different from the wireless system according to first or second exemplary embodiment in that the wide area wireless communication means 120 transmits biometric information to an external system at a predetermined time.

FIG. 5 is a diagram illustrating a communication of a first wireless terminal 100 in the wireless system according to the third exemplary embodiment. The first narrow area wireless communication means 110 receives biometric information (S11). The biometric information may be biometric information obtained by the first biometric information obtaining means 140 provided in the first wireless terminal 100, or biometric information transmitted by the second narrow area wireless communication means 210 and the third narrow area wireless communication means 310 to the first wireless terminal 100. In this case, at a predetermined time T1, the first wireless terminal 100 transmits the received biometric information via the wide area wireless communication means 120 to an external system (S12).

The predetermined time T1 may be set to any time by the user, or may be defined to a particular time in advance. Alternatively, predetermined times T1 may be provided with a predetermined interval. Still alternatively, the predetermined time T1 may be a time when the amount of obtained biometric information attains a certain amount, or a time when the electric accumulation state of the electric accumulation means providing electric power used to drive the first wireless terminal 100 attains a certain criterion. Still alternatively, the predetermined time T1 may be any given point in time when the user gives a command.

When the first wireless terminal 100 frequently receives biometric information, the first wireless terminal 100 transmits the biometric information to the external system by using the wide area wireless communication means 120 on every such occasion, and in this case, the electric power is consumed on every such occasion. In particular, when the first wireless terminal 100 is driven by the electric power provided by the electric accumulation means, this may reduce the operation time of the first wireless terminal 100.

According to the wireless system of the third exemplary embodiment, the biometric information is transmitted to the external system at a predetermined time, and therefore, even when the first wireless terminal 100 frequently receives the biometric information, the electric power consumption can be suppressed.

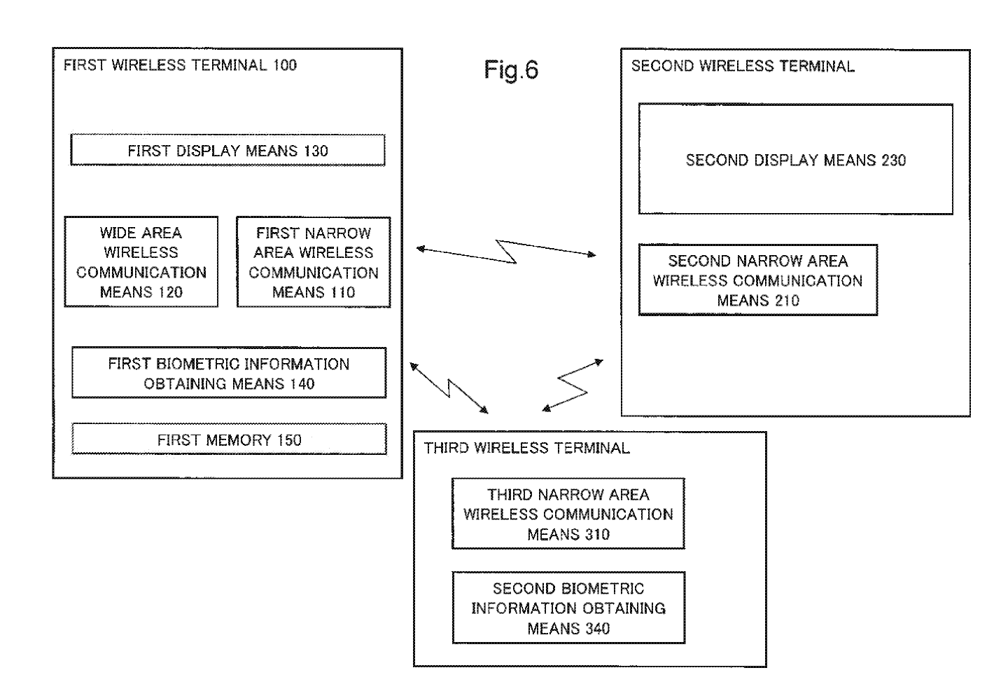

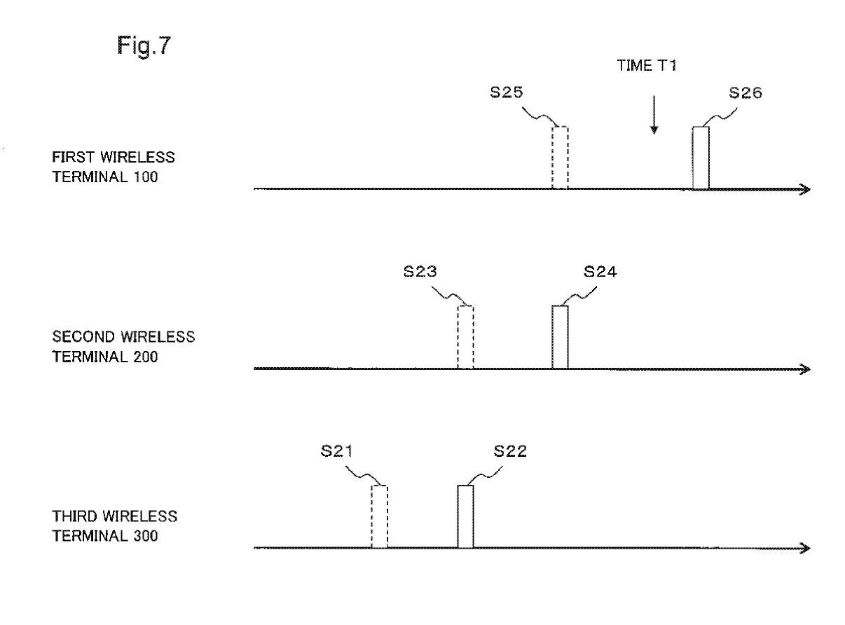

Hereinafter, a specific example of the wireless system according to the third exemplary embodiment will be explained with reference to FIGS. 6 and 7. It is noted that the wireless system according to the third exemplary embodiment is not limited to the following example. FIG. 6 is a schematic diagram illustrating an example of a configuration of the wireless system according to the third exemplary embodiment. The example of the configuration of the wireless system according to the third exemplary embodiment is not different from the configuration of the wireless system according to the second exemplary embodiment except that the first wireless terminal 100 includes a first memory 150 storing information. The first memory 150 can use various kinds of storage means storing information, and can use a flash memory, a hard disk, and the like.

FIG. 7 is a diagram illustrating a communication of the first wireless terminal 100, the second wireless terminal 200, and the third wireless terminal 300 in the example of the wireless system according to the third exemplary embodiment. In the third wireless terminal 300, the second biometric information obtaining means 340 obtains biometric information (S21), and transmits the biometric information via the third narrow area wireless communication means 310 to the second narrow area wireless communication means 210 (S22). The second wireless terminal 200 receives the biometric information (S23).

Subsequently, the second narrow area wireless communication means 210 transmits the biometric information to the first narrow area wireless communication means 110 (S24). The first narrow area wireless communication means 110 receives the biometric information (S25). In this case, the first wireless terminal 100 stores and accumulates the received biometric information to the first memory 150 until a predetermined time T1. When it is the predetermined time T1, the first wireless terminal 100 transmits the biometric information via the wide area wireless communication means 120 to the external system (S26).

According to the wireless system of the third exemplary embodiment, the biometric information is transmitted to the external system at a predetermined time, and therefore, even when the first wireless terminal 100 frequently receives the biometric information from the second wireless terminal 200, the electric power consumption can be suppressed.

It is noted that the first wireless terminal 100 may directly receive the biometric information from the third wireless terminal 300 without relying on the second wireless terminal 200 (S22, S25). Even in this case, the first wireless terminal 100 transmits the biometric information via the wide area wireless communication means 120 to the external system at the predetermined time T1 (S26).

### Fourth Exemplary Embodiment

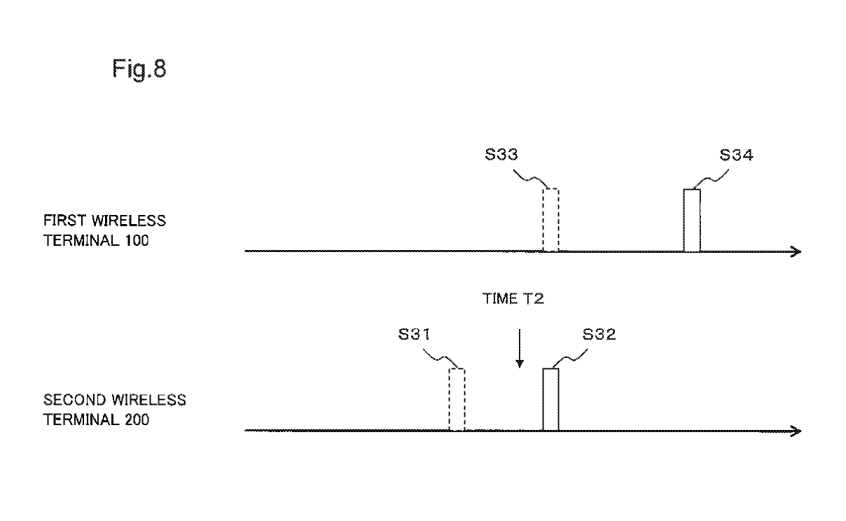

A wireless system according to the fourth exemplary embodiment will be explained with reference to FIG. 8. The configuration of the wireless system according to the fourth exemplary embodiment is not different from the configuration of the wireless system as shown in FIGS. 1 to 4 according to the first and second exemplary embodiments. The wireless system according to the fourth exemplary embodiment is different from the wireless system according to first to third exemplary embodiments in that the second narrow area wireless communication means 210 transmits biometric information to the first narrow area wireless communication means 110 at a predetermined time.

FIG. 8 is a diagram illustrating a communication of a first wireless terminal 100 and a second wireless terminal 200 in the wireless system according to the fourth exemplary embodiment. The second wireless terminal 200 receives biometric information (S31). The biometric information may be biometric information transmitted by the first narrow area wireless communication means 110 to the second wireless terminal 200, or may be biometric information transmitted by the third narrow area wireless communication means 310 to the second wireless terminal 200.

In this case, when it is a predetermined time T2, the second wireless terminal 200 transmits the received biometric information to the first narrow area wireless communication means 110 (S32). The first narrow area wireless communication means 110 receives biometric information (S33), and the wide area wireless communication means 120 transmits the biometric information to an external system (S34).

The predetermined time T2 may be set to any time by the user, or may be defined to a particular time in advance. Alternatively, predetermined times T2 may be provided with a predetermined interval. Still alternatively, the predetermined time T2 may be a time when the amount of obtained biometric information attains a certain amount, or a time when the electric accumulation state of the electric accumulation means providing electric power used to drive the second wireless terminal 200 attains a certain criterion. Still alternatively, the predetermined time T2 may be any given point in time when the user gives a command.

When the second wireless terminal 200 frequently receives biometric information, the second wireless terminal 200 transmits the biometric information to the external system by using the second narrow area wireless communication means 210 on every such occasion, and in this case, the electric power is consumed on every such occasion. In particular, when the second wireless terminal 200 is driven by the electric power provided by the electric accumulation means, this may reduce the operation time of the second wireless terminal 200.

According to the wireless system of the fourth exemplary embodiment, the biometric information is transmitted to the external system at a predetermined time, and therefore, even when the second wireless terminal 200 frequently receives the biometric information, the electric power consumption can be suppressed.

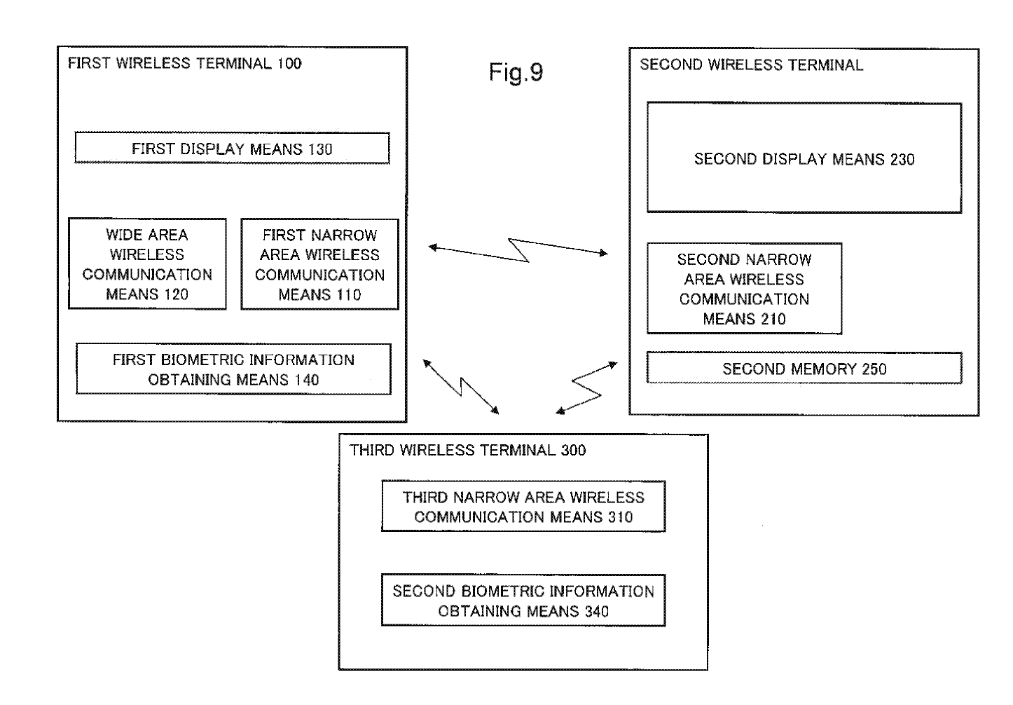

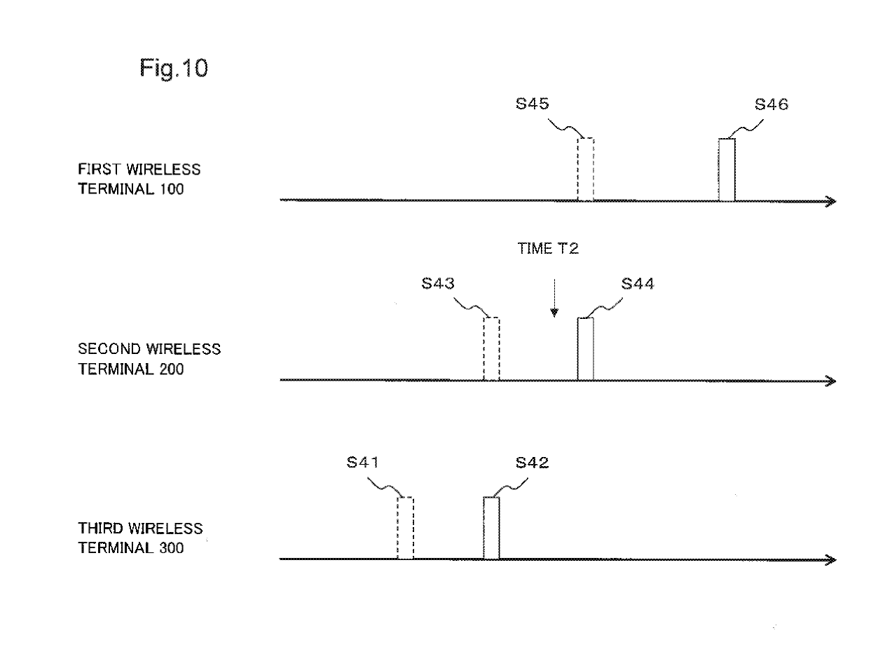

Hereinafter, an example of the wireless system according to the fourth exemplary embodiment will be explained with reference to FIGS. 9 and 10. It is noted that the wireless system according to the fourth exemplary embodiment is not limited to the following example. FIG. 9 is a schematic diagram illustrating a configuration of an example of the wireless system according to the fourth exemplary embodiment. The configuration of the wireless system according to the fourth exemplary embodiment is not different from the configuration of the wireless system according to the second exemplary embodiment except that the wireless system according to the fourth exemplary embodiment includes a second memory 250 storing information. The second memory 250 can use various kinds of storage means storing information, and can use a flash memory, a hard disk, and the like.

FIG. 10 is a diagram illustrating a communication of the first wireless terminal 100, the second wireless terminal 200, and the third wireless terminal 300 in the example of the wireless system according to the fourth exemplary embodiment. In the third wireless terminal 300, the second biometric information obtaining means 310 obtains biometric information (S41), and transmits the biometric information via the third narrow area wireless communication means 310 to the second narrow area wireless communication means (S42). The second wireless terminal 200 receives the biometric information (S43).

In this case, the second wireless terminal 200 stores and accumulates the received biometric information to the second memory 250 until a predetermined time T2. When it is the predetermined time T2, the second narrow area wireless communication means 210 transmits the biometric information to the first narrow area wireless communication means 110 (S44). The first narrow area wireless communication means 110 receives the biometric information (S45), the wide area wireless communication means 120 transmits the biometric information to the external system (S46).

According to the wireless system of the fourth exemplary embodiment, the biometric information is transmitted to the external system at a predetermined time, and therefore, even when the second wireless terminal 200 frequently receives the biometric information, the electric power consumption can be suppressed.

### Fifth Exemplary Embodiment

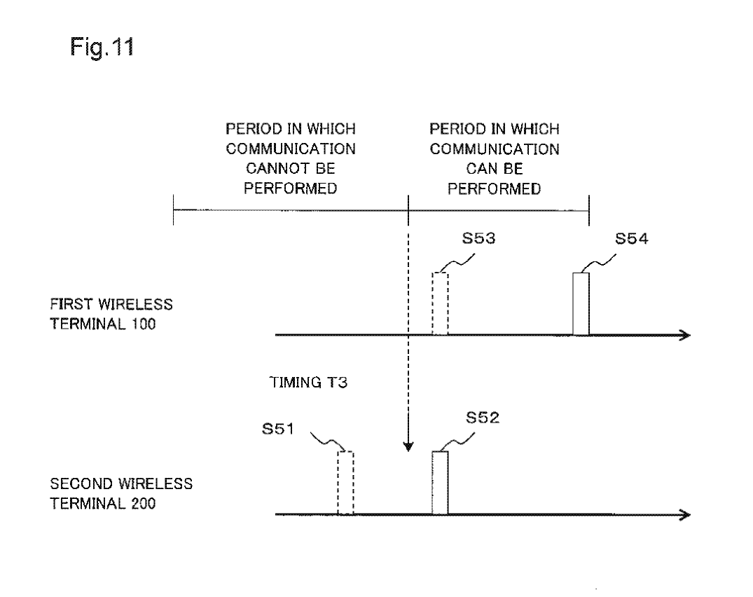

A wireless system according to the fifth exemplary embodiment will be explained with reference to FIG. 11. The configuration of the wireless system according to the fifth exemplary embodiment is not different from the configuration of the wireless system as shown in FIGS. 1 to 4 according to the first and second exemplary embodiments. The wireless system according to the fifth exemplary embodiment is different from the wireless system according to the first to fourth exemplary embodiments in that the second narrow area wireless communication means transmits biometric information when the second narrow area wireless communication means can communicate with the first narrow area wireless communication means.

FIG. 11 is a diagram illustrating a communication of a first wireless terminal 100 in the wireless system according to the fifth exemplary embodiment. The second wireless terminal 200 receives biometric information (S51). The biometric information may be biometric information transmitted by the first narrow area wireless communication means 110 to the second wireless terminal 200, or may be biometric information transmitted by the third narrow area wireless communication means 310 to the second wireless terminal 200.

In this case, the second narrow area wireless communication means 210 transmits the received biometric information to the first narrow area wireless communication means 110 at a point in time T3 when the second narrow area wireless communication means 210 can communicate with the first narrow area wireless communication means 110 (S52). More specifically, the second narrow area wireless communication means 210 transmits the received biometric information to the first narrow area wireless communication means 110 at a point in time when the communication-impossible period to the communication-possible period. The first narrow area wireless communication means 110 receives the biometric information (S53), and the wide area wireless communication means 120 transmits the biometric information to an external system (S54).

In many cases, the user often brings the first wireless terminal 100 with him or her when the user goes outside. When the user brings the first wireless terminal 100, the second wireless terminal 200 is out of a range in which the first narrow area wireless communication means 110 and the second narrow area wireless communication means 210 can communicate with each other. According to the wireless system of the fifth exemplary embodiment, the second narrow area wireless communication means 210 transmits the biometric information at a point in time T3 when the second narrow area wireless communication means 210 can communicate with the first narrow area wireless communication means 110. Therefore, the biometric information is prevented from being transmitted when first narrow area wireless communication means 110 and the second narrow area wireless communication means 210 cannot communicate with each other, and the consumption of the electric power by the second wireless terminal 200 can be reduced.

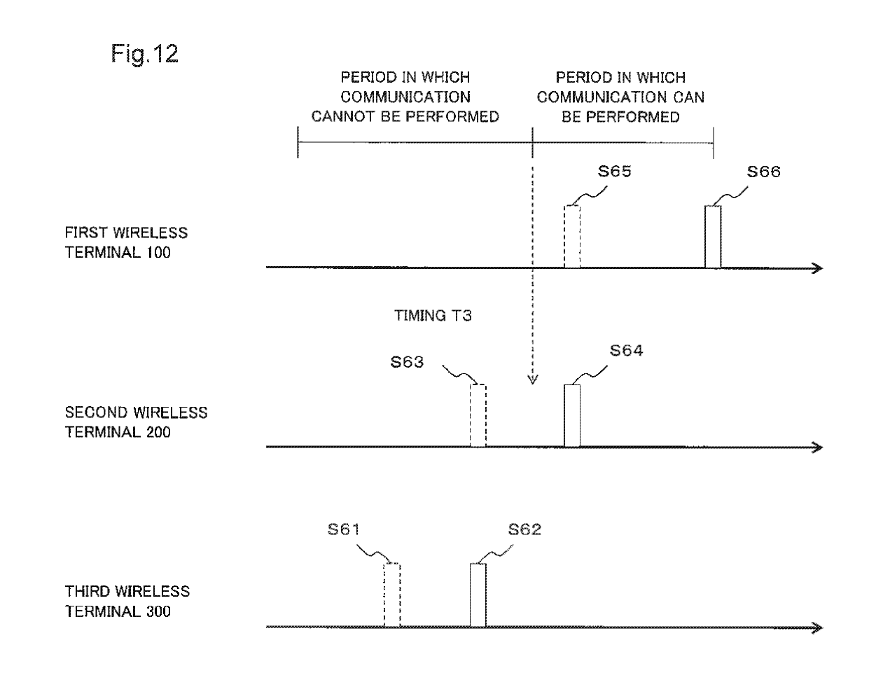

An example of the wireless system according to the fifth exemplary embodiment will be hereinafter explained with reference to FIG. 12. It is noted that the wireless system according to the fifth exemplary embodiment is not limited to the following example. The configuration of the wireless system according to the fifth exemplary embodiment is the same as the configuration as shown in FIG. 9 which is a schematic diagram illustrating a configuration of an example of the wireless system according to the fourth exemplary embodiment.

FIG. 12 is a diagram illustrating a communication of the first wireless terminal 100, the second wireless terminal 200, and the third wireless terminal 300 in the wireless system according to the fifth exemplary embodiment. In the third wireless terminal 300, the second biometric information obtaining means 310 obtains biometric information (S61), and transmits the biometric information via the third narrow area wireless communication means 310 to the second narrow area wireless communication means (S62). The second wireless terminal 200 receives the biometric information (S63).

In this case, the second wireless terminal 200 stores and accumulates the received biometric information to the second memory 250 at a point in time T3 when the second narrow area wireless communication means 210 can communicate with the first narrow area wireless communication means 110. When the second narrow area wireless communication means 210 can communicate with the first narrow area wireless communication means 110, the second narrow area wireless communication means 210 transmits the biometric information to the first narrow area wireless communication means 110 (S64). The first narrow area wireless communication means 110 receives the biometric information (S65), and the wide area wireless communication means 120 transmits the biometric information to an external system (S66).

According to the wireless system to the fifth exemplary embodiment, the second narrow area wireless communication means 210 transmits biometric information at a point in time when the second narrow area wireless communication means 210 can communicate with the first narrow area wireless communication means 110. Therefore, the second wireless terminal 200 is prevented from transmitting the biometric information when the first narrow area wireless communication means 110 and the second narrow area wireless communication means cannot communicate with each other, and the consumption of the electric power can be reduced.

The wireless system and the control method of the wireless system according to the present invention have been explained on the basis of the above exemplary embodiments, but are not limited to the above exemplary embodiments. It is to be understood that the wireless system and the control method of the wireless system according to the present invention include various kinds of modifications, changes, and improvements of the above exemplary embodiments within the scope of the present invention and on the basis of the basic technical concept of the present invention. In addition, various kinds of disclosed elements can be combined, replaced, or selected in various manners within the frame of the claims of the present invention. Further problems to be solved, objects, and extended forms of the present invention will also be clearly understood from the entire disclosure of the present invention including claims.

This application claims the priority based on Japanese Patent Application No. 2012-276369 filed on Dec. 19, 2012, and the entire disclosure thereof is incorporated herein by reference.

### INDUSTRIAL APPLICABILITY

The present invention can be applied to services and the like for obtaining biometric information about biometrics of a user, and providing to the user on the basis of the information, or allowing a corporation to use the information for marketing and transmitting an advertisement suitable for the preference of the user.

### REFERENCE SIGNS LIST

100 First wireless terminal
110 First narrow area wireless communication means
120 Wide area wireless communication means
130 First display means
140 First biometric information obtaining means
150 Fifth narrow area wireless communication means
200 Second wireless terminal
210 Second narrow area wireless communication means
230 Second display means
250 Fourth narrow area wireless communication means
300 Third wireless terminal
310 Third narrow area wireless communication means
340 Second biometric information obtaining means
500 Portable information device
501 First data transmission and reception unit
502 First measurement unit
503 Storage unit
504 Individual information storage unit
505 Control unit
506 Battery power supply unit
600 Biometric information measurement device
601 Second data transmission and reception unit
602 Second measurement unit
603 Wireless communication unit
604 Power supply unit
605 Biometric information measurement device display unit
606 Biometric information measurement device operation unit
606a Biometric information measurement device operation unit
606b Enter button

1. A wireless system comprising:
a first wireless terminal including a wide area wireless communication unit connecting to an external system, a first narrow area wireless communication unit, a first display unit, and a first biometric information obtaining device configured to obtain user's biometric information; and
a second wireless terminal including second narrow area wireless communication unit capable of communicating with the first narrow area wireless communication unit, and a second display unit,
wherein the first display unit is smaller than the second display unit means.

2. The wireless system according to claim 1, wherein
the first narrow area wireless communication unit transmits information related to the biometric information obtained by the first biometric information obtaining device to the second narrow area wireless communication unit.

3. The wireless system according to claim 1, wherein
the first display unit displays the information related to the biometric information obtained by the first biometric information obtaining device,
the information displayed on the first display unit is transmitted from the first wireless terminal to the second wireless terminal via the first narrow area wireless communication unit and the second narrow area wireless communication unit, and
the information is displayed on the second display unit.

4. The wireless system according to claim 1, wherein
the wide area wireless communication unit transmits the biometric information obtained by the first biometric information obtaining device to the external system.

5. The wireless system according to claim 4, wherein
the first display unit displays information related to the biometric information received from the external system.

6. The wireless system according to claim 4 further comprising a third wireless terminal including a third narrow area wireless communication unit capable of communicating with at least one of the first narrow area wireless communication unit and the second narrow area wireless communication unit, and a second biometric information obtaining device configured to obtain the user's biometric information,
wherein the third narrow area wireless communication unit transmits the biometric information obtained by the second biometric information obtaining device to at least one of the first narrow area wireless communication unit and the second narrow area wireless communication unit,
when the second narrow area wireless communication unit receives the biometric information, the second narrow area wireless communication unit transmits the biometric information to the first narrow area wireless communication unit, and
when the first narrow area wireless communication unit receives the biometric information, the first narrow area wireless communication unit transmits the biometric information to the wide area wireless communication unit, and
the wide area wireless communication unit transmits the biometric information to the external system.

7. The wireless system according to claim 4 further comprising:
a third wireless terminal including:
a second biometric information obtaining device configured to obtain and output the biometric information, and
a third narrow area wireless communication unit configured to output the received biometric information, and consume less electric power than the first narrow area wireless communication unit,
wherein the second wireless terminal further includes a fourth narrow area wireless communication unit configured to consume less electric power than the second narrow area wireless communication unit, and
the biometric information is transferred, in order, from the second biometric information obtaining device via the third narrow area wireless communication unit, the fourth narrow area wireless communication unit, the second narrow area wireless communication unit, the first narrow area wireless communication unit, and the wide area wireless communication unit, and is thereafter transmitted to the external system.

8. The wireless system according to claim 4 further comprising:
a third wireless terminal including:
a second biometric information obtaining device configured to obtain and output the biometric information, and
a third narrow area wireless communication unit configured to output the received biometric information, and consume less electric power than the first narrow area wireless communication unit,
wherein the first wireless terminal further includes a fifth narrow area wireless communication unit configured to consume less electric power than the first narrow area wireless communication unit, and
the biometric information is transferred, in order, from the second biometric information obtaining device via the third narrow area wireless communication unit, the fifth narrow area wireless communication unit, the first narrow area wireless communication unit, and the wide area wireless communication unit, and is thereafter transmitted to the external system.

9. The wireless system according to claim 4, wherein
the wide area wireless communication unit transmits the biometric information to the external system at a predetermined time.

10. The wireless system according to claim 1, wherein
the second narrow area wireless communication unit transmits the biometric information to the first narrow area wireless communication unit at a predetermined time.

11. The wireless system according to claim 1, wherein the second narrow area wireless communication unit transmits the biometric information to the first narrow area wireless communication unit when the second narrow area wireless communication unit can communicate with the first narrow area wireless communication unit.

12. A control method of a wireless system, which includes a first wireless terminal including a wide area wireless communication unit connecting to an external system, a first narrow area a wireless communication unit, a first display unit and a first biometric information obtaining device configured to obtain user's biometric information, and a second wireless terminal including a second narrow area wireless communication unit capable of communicating with the first narrow area wireless communication unit and a second display unit, and where the first display unit is smaller than the second display unit, comprising:
obtaining biometric information using by the first biometric information obtaining device, and
transmitting the biometric information to the external system using by the wide area wireless communication unit.

13. A control method of a wireless system comprising:
in a first wireless terminal,
causing a wide area wireless communication unit communicate with an external network;
obtaining user's biometric information;
causing a first display unit to display information related to the obtained biometric information; and
transmitting the information related to the biometric information displayed on the first display unit via a first narrow area wireless communication unit to a second terminal,
in a second wireless terminal,
receiving the information related to the biometric information from the first wireless terminal via a second narrow area wireless communication unit; and
causing a second displaying unit larger than the first display unit to display the received information about the biometric information.

14. The control method of the wireless system according to claim 13 comprising,
in the first wireless terminal,
transmitting the obtained biometric information via the wide area wireless communication unit to the external system.

15. The control method of the wireless system according to claim 14 comprising,
in the first wireless terminal,
causing the first display unit to display the information related to the biometric information received from the external system.

16. The control method of the wireless system according to claim 14, comprising:
in a third wireless terminal,
obtaining user's biometric information,
transmitting the obtained biometric information via a third narrow area wireless communication unit to at least one of the first wireless terminal and the second wireless terminal,
in the second wireless terminal,
transmitting the obtained biometric information via the second narrow area wireless communication unit to the first wireless terminal when the biometric information is received,
in the first wireless terminal,
transmitting the biometric information via the wide area wireless communication unit to the external system when the biometric information is received.

17. The control method of the wireless system according to claim 14 comprising:
in the first wireless terminal,
transmitting the biometric information via the wide area wireless communication unit to the external system at a predetermined time.

18. The control method of the wireless system according to claim 13 comprising:
in the second wireless terminal,
transmitting the biometric information via the second narrow area wireless communication unit to the first wireless terminal at a predetermined time.

19. The control method of the wireless system according to claim 13 comprising:
in the second wireless terminal,
transmitting the biometric information via the second narrow area wireless communication unit to the first wireless terminal when communication can be performed with the first wireless terminal.

20. A wireless system comprising:
a first wireless terminal including wide area wireless communication means connecting to an external system, first narrow area wireless communication means, first display means, and first biometric information obtaining means configured to obtain user's biometric information; and
a second wireless terminal including second narrow area wireless communication means capable of communicating with the first narrow area wireless communication means, and second display means,
wherein the first display means is smaller than the second display means.
